(19) United States
(12) Patent Application Publication
(10) Pub. No.: US 2004/0078374 A1
(43) Pub. Date: Apr. 22, 2004

(54) Remote database access apparatus, method, and computer program product

(75) Inventor: Don Marlin Hamilton, Sarasota, FL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: RETRIEVAL DYNAMICS CORPORATION, Sarasota, FL

(21) Appl. No.: 10/632,932

(22) Filed: Nov. 7, 2003

Related U.S. Application Data
(60) Provisional application No. 60/400,068, filed on Aug. 2, 2002.

(51) Int. Cl. G06F 17/30; G06F 7/00

(52) U.S. Cl. 707/10

(57) ABSTRACT

A remote database access apparatus, method, and computer program product which enables wireless applications to interact with one or more remote databases, in which the queries by the wireless user are created either in a form or in a command line interface and are converted to queries compatible with the one or more databases by a dynamic retrieval engine which includes a dynamic retrieval manager and dynamic retrieval information server.

### BACKGROUND OF THE INVENTION

1. Field of the Invention

The present invention relates to systems, methods and computer program products relating to accessing remote databases over broadband or low bandwidth narrowband communication wireless links.

2. Discussion of the Background

The use of wireless technology for business applications continues to grow and evolve. A great deal of effort has been expended to develop simple applications including basic text messaging, facsimile, voice mail and other point-to-point communications services. More complicated applications have also been envisioned and, in some cases, developed. These include limited web-based services by which a user of a wireless device attempts to browse information available on web servers and web pages. These wireless web-based applications suffer greatly from bandwidth limitations and has proven to have restrictive and costly commercially viability.

Mobile government, business, and scientific personnel and applications often require access to database information that is not available locally. Concepts have recently been developed for remote access of databases through wireless devices. The few that have been developed tend to rely upon web-based data access services that are commonly available through non-wireless applications. Porting these web-based data access products and services to a wireless environment requires exceedingly large bandwidth and high-speed communications in order to be effective. What is required for wireless database access is more tailored systems and methods for mobile applications and the mobile professional.

Another limitation of current capabilities rests with human-machine interfaces and application database interfaces. Many situations exist where straightforward query formation is required by human and applications, while target databases are constrained by arcane legacy interface protocols, languages, and methods.

In the interest of providing more “human” interfaces, other developers have added complexity by pursuing natural language conversion of human language to database interactions both over wireless and non-wireless links. An example of this natural language approach is found in U.S. Pat. No. 6,144,989 to Hodiat et al. The use of natural language technologies requires expensive and complicated interface software to translate natural language strings to existing hard coded database access protocols. These natural language approaches can also result in unpredictable results. What the present inventors recognized is required is an affordable, expandable, predictable, low amount of bandwidth, and human friendly wireless interface to various databases that include, but not limited to SQL, Informix, Oracle, IBM, Siebel, legacy, and custom.

### SUMMARY OF THE INVENTION

The present invention addresses and resolves the above-identified as well as other limitations with conventional systems and methods. The present invention provides a novel low cost and easy to implement infrastructure and technology for remote access to existing databases via wireless links. The present invention exploits the low bandwidth/throughput, asynchronous features of e-mail to engage a dynamic retrieval engine which, in turn, translates and mediates wireless client interactions with hard-coded databases that are of interest to the mobile professional. The present invention integrates numerous bandwidth saving approaches and human factors considerations to provide an overarching capability for mobile professionals and applications to access data. This includes the use of e-mail, the use of forms and pre-stored queries, and a dynamic retrieval infrastructure, which interfaces with existing legacy databases.

### BRIEF DESCRIPTION OF THE DRAWINGS

A more complete appreciation of the present invention and many of the attendant advantages thereof will be readily obtained as the same becomes better understood by reference to the following detailed description and accompanying drawings:

FIG. 1 is a block diagram that illustrates the overarching architecture of the present invention;

FIG. 2 is a block diagram that illustrates dynamic retrieval environment of the first embodiment of the present invention;

FIG. 3 is a block diagram that illustrates dynamic retrieval environment of the second embodiment of the present invention;

FIG. 4 is a block diagram that illustrates the dynamic retrieval data environment of the present invention;

FIG. 5 is a flowchart that illustrates the database retrieval methods of the present invention; and

FIG. 6 is a flowchart of a security and authentication method of the present invention; and

FIG. 7 is a block diagram that illustrates an example computer block diagram.

### DETAILED DESCRIPTION OF PREFERRED EMBODIMENTS

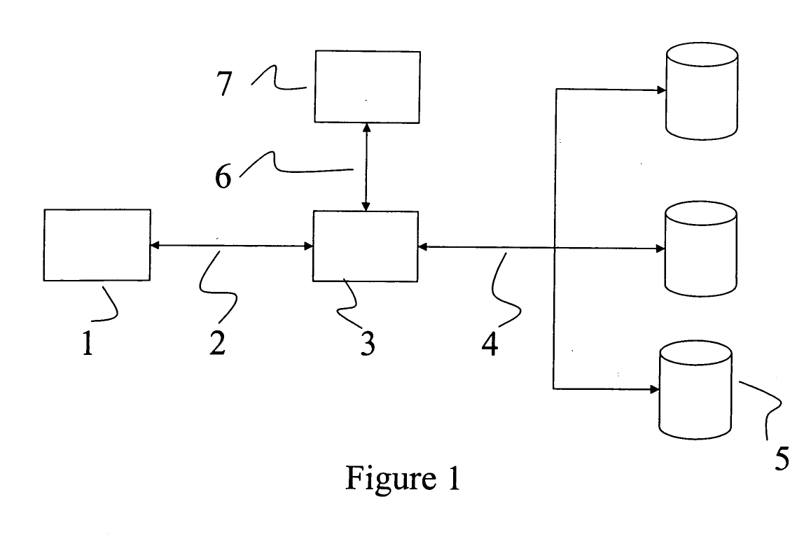

Referring now to the drawings, wherein like reference numerals designate identical or corresponding parts throughout the several views, FIG. 1 illustrates the overarching architecture of the present invention. A wireless application and/or device 1 is in communication with a dynamic retrieval environment 3 via a wireless link that supports e-mail. The wireless link can be narrowband or wideband, line-of-sight or beyond line-of-sight, short-range or long-range, using communication networks such as GSM, GPRS, 802.11, TDMA, CDMA, or other communication paths. The wireless link may be operated in accordance with 802.11, IMT 2000, WCDMA, Bluetooth, or any other wireless standard. The wireless link is communications protocol independent. The dynamic retrieval environment 3 is in turn in communication with remote world databases 5 via a back end link 4. Optionally, a computer or other non-wireless data and information processor 7 may be in communication with the dynamic retrieval environment 3 via a non-wireless or wireless link 6. A more complete description of how email operations is described in Gralla, P. “How the Internet Works, Millennium Edition”, Macmillan Computer publishing, USA, ISBN 0-7897-2132-5, Part 4, pages 80-115, the entire contents being incorporated herein by reference

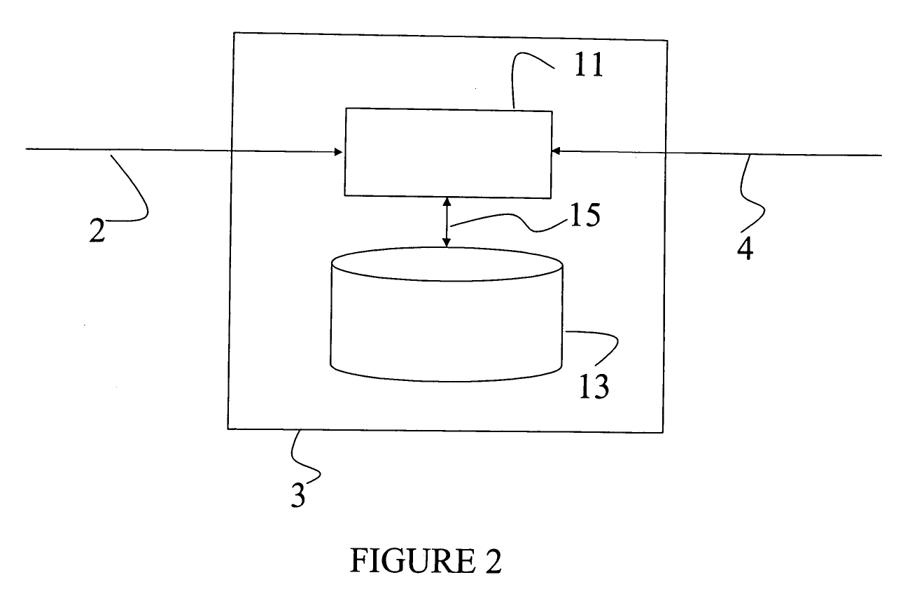

An overview of the dynamic retrieval environment 3 is shown in FIG. 2. The dynamic retrieval environment 3 contains a dynamic retrieval services manager 11 which receives and transmits e-mail via the wireless link 2 and which queries and receives responses from the world databases 5 via the back end link 4. The dynamic retrieval services manager 11 interacts with a dynamic retrieval server 13 via a retrieval manager/retrieval server link 15. The dynamic retrieval services manager 11 may also exchange e-mail or files or other information with a computer or other information processor 7 (not shown) via a wireless or non-wireless link 6 (not shown).

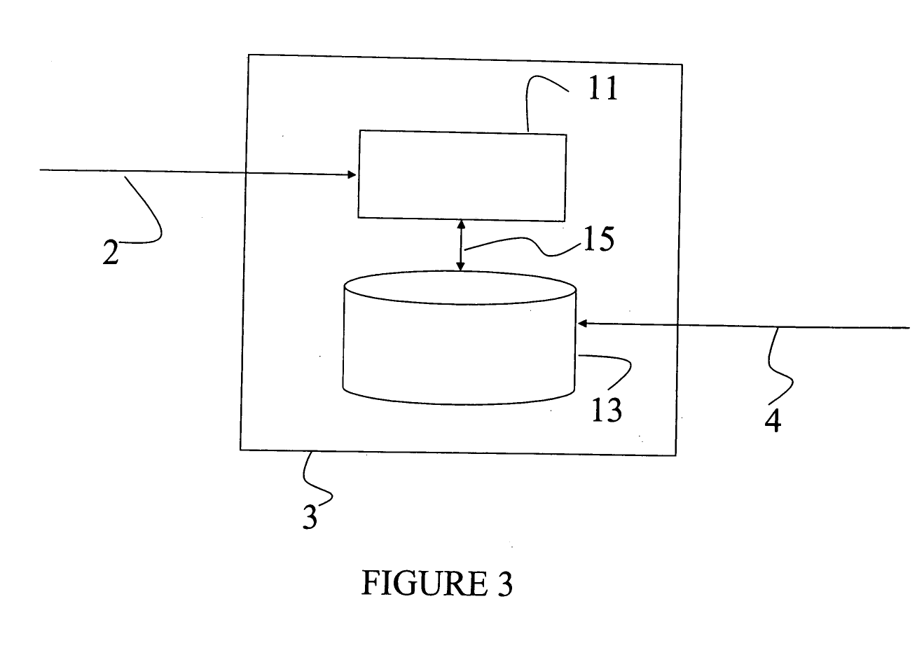

FIG. 3 shows an alternative embodiment in which the dynamic retrieval services manager 11 interacts with a remote wireless application 1 via a wireless link 2 as in FIG. 2. However, queries and responses between the dynamic retrieval engine 3 and the world databases 5 are via the dynamic retrieval server 13 via the back end link 4 rather than via the dynamic retrieval services manager 11, as shown previously in FIG. 2.

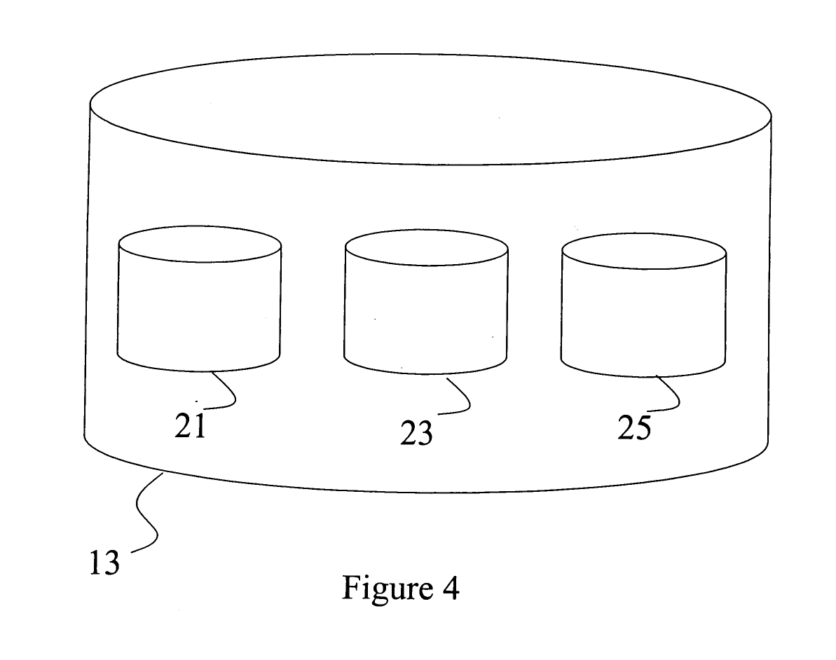

As shown in FIG. 4, the dynamic retrieval server 13 contains at least three internal data managers and/or servers (e.g., the internal data managers may be one database with multiple tables, therefore these data managers may also be contained within a single server). These data managers and/or servers include a world database management server 21, a world database output field validation server 23, and a world database data-mapping server 25. The world database management server 21 contains standardized world database address information and fields for actions and communications. The world database output field validation server 23 contains translation tables so that queries made by the user in the wireless application 1 are converted from a single input value to a multitude of output values that are appropriate for the world databases 5 that contain the data required by the user. For example, a simple form-based user query regarding real estate listings can be converted into a case-specific multiple listing service (MLS) database command line interface sequence. The world database output field validation server 23 also performs value and type validation and conversion. The world database data-mapping server 25 contains table and field information from the target world databases 5 and their correspondences to reports forwarded to the wireless application 1 via the wireless link 2.

The user query may be an email, a Short Message Service (SMS) message, a Multi-Media Service (MMS) message, a hyper text transfer protocol (HTTP) message, or a Wireless Application Protocol (WAP) message

The dynamic retrieval engine 3 supports multi-thread multi-tasking operations. This device contains program servers and related logic as well as views/snapshots of the world databases and includes tables that can be predefined. The dynamic retrieval engine 3 also stores user information and metadata about the user as well as the world databases in order to provide quick and efficient translations of data. An advantage of using a dynamic retrieval engine in between remote applications 1 and world databases 5 are numerous. One of these is the assigning to a third party responsibility for maintaining the interface between wireless applications and the difficult and expensive to upgrade, world database 5 sites and systems. By replacing this responsibility with a neutral third party, which can stay abreast of evolving wireless communications protocols, costs to the maintainers of the world databases 5 are minimized while user flexibility and overall system performance is enhanced. Another advantage of this architecture is the third party's ability to interact with multiple databases as on behalf of the wireless device user and by providing the wireless user with a single point of access to multiple world databases 5.

There are at least two modes of data access presented to the user in the wireless application 1. The preferred mode is through a predetermined form in which the user is presented with an electronic table or form to enter values or ranges of values that correspond to questions of interest to the user. A second mode of querying the world databases 5 is through one or more command line interfaces that correspond to one or more of the target world databases 5. In both cases, the form and/or the command line string created in the remote application 1 is converted to one or more predetermined queries by the dynamic retrieval server 13 through interaction with the tables and servers in the world database management server 21, the world database output field validation server 23, and the world database data mapping server 25. The queries formed by the user in the remote application 1, after conversion by the dynamic retrieval server 13, are forwarded to the world databases 5 either by the dynamic retrieval server 13 or, preferably, by the dynamic retrieval services manager 11. The back end link 4 is preferably configured to support OLEDB object linking embedded database and/or ODBC connections. The back end link 4 may also be configured to support XML or SOAP communications. Other protocols include File Transfer Protocol (FTP) and Real Estate Transaction Services (RETS) protocol. In addition, other communications and connection methods are possible to include replication and other database synchronization protocols. There are no limits in the formats for the world databases. The world databases 5 can be SQL, SYMBOL, ORACLE, SYBASE, SAP, ERP, IBM (AS 400), or other formats. Database formats may be relational, object, delineated, XML based, or any other structured database. The databases within the dynamic retrieval server 13 are expandable to accommodate any number of world databases in any format with no limitation as to number and type of data fields and data tables.

Via the remote wireless application 1, the user is able to use stored forms to develop queries against one or more world databases. The user is also able to create new standardized forms with a form manager. The user is also able to create and save standard queries. Queries and forms can be saved for reuse. In all cases, these forms-based queries are sent from the remote application 1 via e-mail over the wireless link 2 to the dynamic retrieval services manager 11. The dynamic retrieval services manager 11 interacts with the dynamic retrieval server 13 to formulate the proper queries against the proper databases. These backend queries are formed dynamically when the user's query is received depending on the user's initial query, the user's permissions and other factors.

The use of e-mail over the wireless link 2, as well as the use of predetermined operator selectable forms based queries, provides for rapid response to user queries due to the fact that e-mail and forms based textural queries provides for a much reduced overhead and communications burden than traditional database queries. A real estate multiple listing service (MLS) example of a predetermined operator selectable form may include location information, price range, availability date and other features predetermined to be of high-interest to a real estate agent. However, the agent is able to select/deselect the form's predetermined fields or ranges to tailor the query to the agent's interests/preferences. E-mail based interfaces are not limited to a particular e-mail type or commercial vendor. It is envisioned that all existing and future e-mail type services will be supported via the wireless link 2.

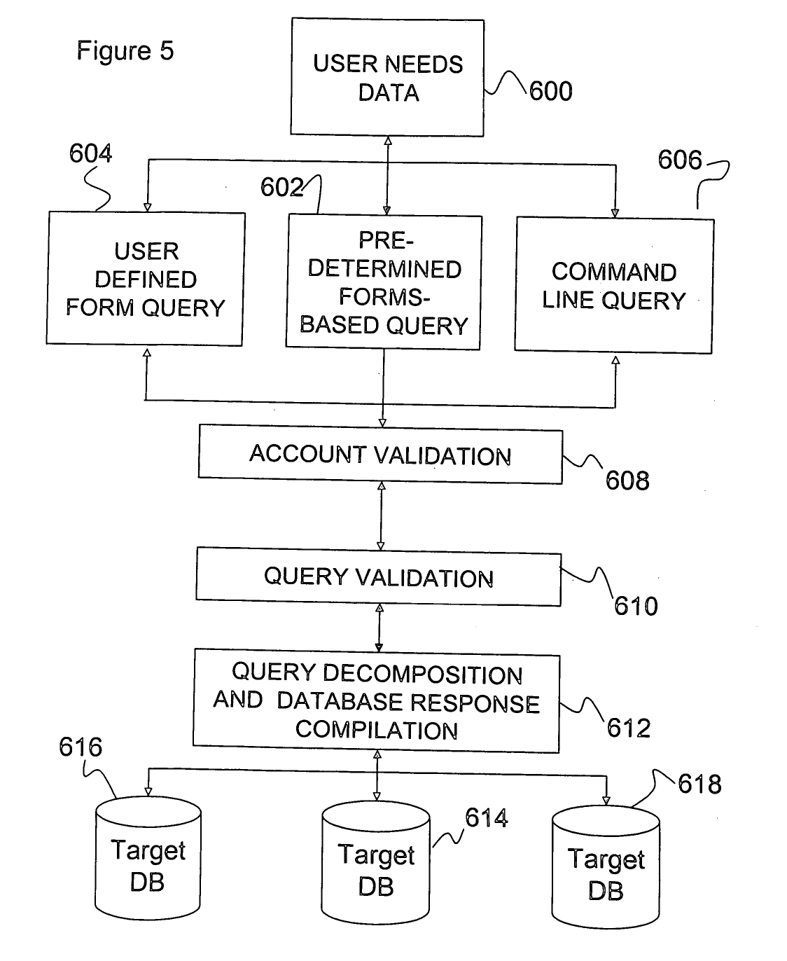

The method associated with this invention is as follows. A mobile user desires access to information contained in one or more world databases via the wireless link. The user develops and formulates a query via the wireless application 1 and sends the query over the wireless link 2. The query is received by the dynamic retrieval services manager 11 and is forwarded to the dynamic retrieval server 13 for query reformulation, validation and ultimately forwarding to one or more world databases. The world databases 5 receive their respective queries from the dynamic retrieval server 13, either directly or via the dynamic retrieval services manager 11, and reply to the dynamic retrieval server 13, again either directly or via the dynamic retrieval services manager 11. These responses are mapped and merged into a single e-mail response that is sent to the wireless application 1 via the wireless link 2. E-mails are exchanged between the wireless application 1 and the dynamic retrieval services manager 11 via any available commercial wireless e-mail services and follow whichever protocol and mailbox routines supported and enforced by existing or future wireless e-mail capabilities. FIG. 5 is a flowchart representation of the method described above beginning with a user forming a query 600. The user then composes the query via a predetermined form 602, via a user-defined or user-modified form 604, or via a command line interface 606. The user sends the query 608 which is then received, subject to administrative review and decomposition 608, validated and converted, to queries or forms specific to the world databases 610, and sent to one or more appropriate target databases 612. The responses of the target databases are returned for conversion, compilation, and forwarding to the user who initiated the query.

If a user has access to non-wireless communications links, the user can interact with the world databases 5 with a non-wireless information processor 7 in a similar manner. Responses to and from the non-wireless information processor 7 are not restricted to just e-mail formats. Other data exchange formats such as web and file transfer are possible and envisioned over the non-wireless link 6.

Advantages of using XML over the back end link include easy firewall configuration, platform independence and easy changeability and scaleability. Disadvantages include a slight increase in bandwidth as compared to other protocols. In place of XML, SOAP, ODBC and/or OLEDB link may be used on the back end. An advantage to this would be increased speed and decreased overhead requirements. The advantages of using e-mail relate to low communications overhead, reliability, high speed, simplicity, and flexibility. Email can also allow for query/response store and forward operations when system and limber are busy.

The current architecture provides advantages over alternative approaches in terms of training and human factors. With this invention users are presented with an easy-to-understand, forms-based, repeatable interface between multiple databases that may have very diverse interface requirements and protocols. In addition, the option of a command line interface presents flexibility to users who are accustomed to direct interactions with one or more particular databases. Note that a command line interface for one world database 5 can be converted by the dynamic retrieval engine 3 to queries of other world databases 5.

The system may also be configured with an integrated geo-location (e.g., GPS) registration and exploitation capability to allow for geo-searching of the world databases 5 based on the location of the wireless application 1. Geo-searching of the world databases 5 may be performed based on user supplied geo-reference data to include point, line, polygon, name and other geospatial identifiers.

The system may also be configured with link encryption (e.g., triple-DES) on one or more links. Also, account privacy may be supported by the use of passwords and other privacy and security measures. Account information and user profiles are stored and managed in the dynamic retrieval services manager 11. In addition, administrative access to accounting and other customer and system information may be controlled via passwords and/or user profiles.

The system may also be configured with a Geospatial Information System (GIS) exploitation capability to allow for map-based query and response between the mobile application 1 and the world databases 5. GIS functionality may also be provided at the computer or other information processor 7.

Query formulation in the dynamic retrieval engine 3 is affected by a user profile and permissions stored in the dynamic retrieval services manager 11. Query formulation may also be influenced by the user's role such as system administrator, account manager, superuser, etc.

Responses to user queries may be a complete response, a snapshot or other user defined format or response output. A snapshot response is a predefined or user-defined subset of the complete response. Users can determine whether to forward a snapshot response to the wireless application 1 and, in parallel a complete response to the computer 7. Similarly, users can assign variable numbers of responses to be sent to both the wireless application 1 and the computer 7 (e.g., 10 “best” records sent to the wireless application 1 and 100 “best” records sent to the computer 7). Users can also schedule queries and query-repeats both in terms of when the query will execute and how often it will execute.

Queries can accommodate multiple data types (numeric, alphanumeric, etc.) as well as specific values and ranges. Users can weight parameters within a query as well set multiple ranges (e.g., preferred, acceptable, unacceptable, etc.), thus allowing the dynamic retrieval engine 3 to prioritize query results in terms of quality and/or relevance.

Query results can be forwarded to multiple email accounts as well as to remote printing, mailing and faxing sites.

In addition to database query operations, the system can also support database writing and interaction services. Database interaction includes querying one or more world databases 5, collecting and manipulating the responses (e.g., add, merge, rank, etc.) and executing new query or write operations based on the manipulated results.

The dynamic retrieval engine 3 is not limited to converting between multiple heterogeneous data structures and types. The dynamic retrieval engine 3 also accommodates and converts multiple units of measure.

Not only are the query forms configurable by the user of the wireless application 1. Query responses are also configurable in terms of output field order, length and visual display. Also profile information, while preferably managed via the computer 7, can be managed via a user configurable user-profile screen and menu. Similarly, an account manager terminal (not shown) can be interfaced to the dynamic retrieval engine 3 and can be operated through user configurable displays.

Optional features of the present invention include exchanging photographs and other digitized imagery; voice recognition; and audit tracking.

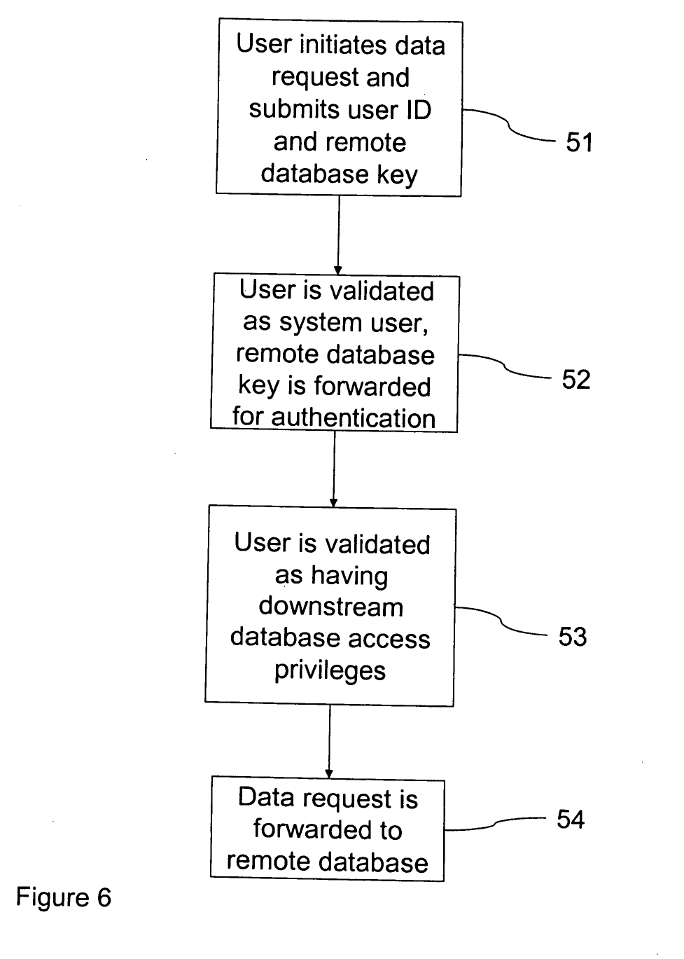

In one embodiment of the present invention, security is provided by user password and database access authentication. One version of this authentication process is shown in FIG. 6. A user initiates contact with the system with a communications that includes user identification and remote database access information (51). The system validates the user based on a user identification code (52). If the user identification code is invalid, the connection is terminated or an access-denied message is sent to the user. If the user identification code is valid, a remote database access key is then forwarded for determination if the user is authorized to access the information in the remote database (53). If the remote database access key is invalid, the connection is either terminated or an access-denied message is sent to the user. If the remote database access key is valid, the database query is forwarded to the remote database, where a response is formulated, converted, and relayed back to the user (54).

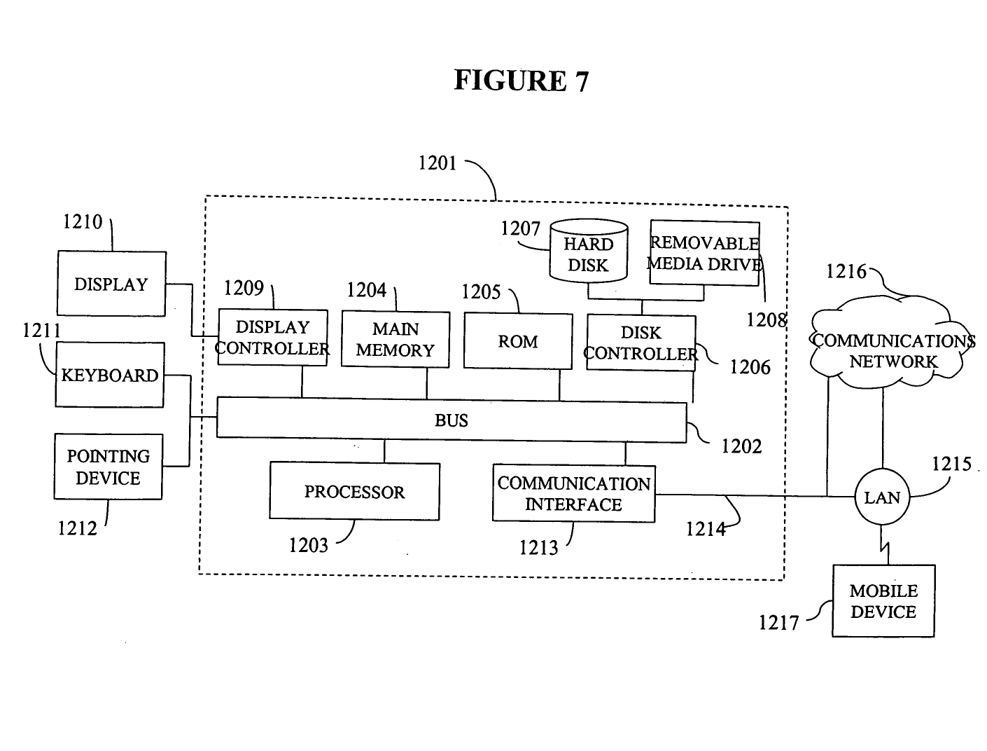

FIG. 7 illustrates a computer system 1201 upon which an embodiment of the present invention may be implemented. Computer design is discussed in detail in STALLINGS, W., Computer Organization and Architecture, 4th ed., Upper Saddle River, N.J., Prentice Hall, 1996, the entire contents of which is incorporated herein by reference. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire, and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214, and the communication interface 1213. Moreover, the network link 1214 may provide a connection through a LAN 1215 to a mobile device 1217 such as a personal digital assistant (PDA) laptop computer, or cellular telephone.

Obviously, numerous modifications and variations of the present invention are possible in light of the above teachings. It is therefore to be understood that within the scope of the appended claims, the invention may be practiced otherwise than as specifically described herein.

1. An information management apparatus configured to enable a wireless application to interact with remote data, comprising:
a dynamic retrieval services manager configured to manage information received from an external wireless device via a wireless link; and
a dynamic retrieval server connected to the dynamic retrieval services manager, said dynamic retrieval server comprising:
a database management server configured to receive, parse, validate, and store a standardized query sent by the external wireless device,
a database output field validation server configured to convert a set of standardized query field name and value pairs to a set of field name and value pairs corresponding to a predetermined remote database format, and
a database data-mapping server configured to host a correspondence between a set of standardized query structures and relationships and a set of structures and relationships corresponding to said predetermined remote database format.

2. The information management apparatus of claim 1, said standardized query comprising:
one of an email message, an SMS message, an MMS message, an HTTP message, and a WAP message.

3. The information management apparatus of claim 1, wherein one of the dynamic retrieval services manager and the dynamic retrieval server comprise:
an output port connecting the information management apparatus to a remote database.

4. The information management apparatus of claim 3, wherein said remote database comprises:
a multiple listing database.

5. The information management apparatus of claim 1, said dynamic retrieval services manager further comprising:
a program server configured to manage information processes of the dynamic retrieval server and comprising at least one of
a set of remote database views,
a set of information management tables, and
a set of user account data.

6. The information management apparatus of claim 1, wherein said predetermined remote database format is selected from a list comprising:
SQL;
SYMBOL;
ORACLE;
SYBASE;
SAP;
ERP;
IBM AS 400;
relational;
object;
delineated;
XML; and
structured.

7. The information management apparatus of claim 3, wherein said output port is configured to communicate via a communications protocol selected from a list comprising:
an OLEDB protocol;
an ODBC protocol;
an XML protocol;
a SOAP protocol;
a RETS protocol;
a FTP protocol;
a database replication protocol; and
a database synchronization protocol.

8. The information management apparatus of claim 1, said dynamic retrieval services manager further comprising:
a forms manager.

9. The information management apparatus of claim 1, further comprising at least one of:
a historical log; and
a user authentication and remote database access authentication system.

10. An information management system configured to enable a wireless application to interact with remote data, comprising:
a wireless device configured to transmit information contained in a predetermined query form via a wireless link;
an information management apparatus configured to receive and process the information transmitted by the wireless device, said information management apparatus comprising
a dynamic retrieval services manager configured to manage the information received from the wireless device, and
a dynamic retrieval server connected to the dynamic retrieval services manager, said dynamic retrieval server comprising
a database management server configured to receive, parse, validate, and store the information received from the wireless device,
a database output field validation server configured to convert a set of standardized query field name and value pairs to a set of field name and value pairs corresponding to a predetermined remote database format, and
a database data-mapping server configured to host correspondences between a set of standardized query structures and relationships and a set of structures and relationships corresponding to said predetermined database format;
a remote database comprising said at least one predetermined database format.

11. The information management system of claim 10, said predetermined query form comprising:
one of an email message, an SMS message, an MMS message, an HTTP message, and a WAP message.

12. The information management system of claim 10, further comprising:
a computing device connected to the information management apparatus and configured to perform at least one of managing account information, creating and editing forms, and updating tables and algorithms in the dynamic retrieval server.

13. The information management system of claim 10, further comprising at least one of:
a link encryption device; and
a geographic information system.

14. The information management system of claim 10, wherein one of dynamic retrieval services manager and the dynamic retrieval server comprise:
an output port connecting the information management apparatus to said remote database.

15. The information management system of claim 13, wherein said remote database comprises:
a multiple listing database.

16. The information management system of claim 10, said dynamic retrieval services manager further comprising:
a program server configured to manage information processes of the dynamic retrieval server and comprising at least one of
a set of remote database views,
a set of information management tables, and
a set of user account data.

17. The information management system of claim 10, wherein said predetermined remote database format is selected from a list comprising:
SQL;
SYMBOL;
ORACLE;
SYBASE;
SAP;
ERP;
IBM AS 400;
relational;
object;
delineated;
XML; and
structured.

18. The information management system of claim 14, wherein said output port comprises a communications protocol selected from a list comprising:
an OLEDB protocol;
an ODBC protocol;
an XML protocol;
a SOAP protocol;
a RETS protocol;
a FTP protocol;
a database replication protocol; and
a database synchronization protocol.

19. The information management system of claim 10, said dynamic retrieval services manager further comprising:
a forms manager.

20. The information management system of claim 10, said information management apparatus further comprising at least one of:
a historical log; and
a user authentication and remote database access authentication system.

21. An information management method configured to enable wireless applications to interact with remote data, comprising steps of:
sending a preformatted query message containing user and query information by a wireless device over a wireless link;
receiving the preformatted query message by a dynamic retrieval services manager for subsequent forwarding to a dynamic retrieval server;
reformulating and validating the preformatted query message by the dynamic retrieval server for subsequent forwarding to a remote database as a database query;
forming and sending a database response from the remote database over a back-end link to the dynamic retrieval services manager for subsequent forwarding to the dynamic retrieval server;
reformulating the database response by the dynamic retrieval server for subsequent compilation and forwarding in a preformatted response message to the wireless device; and
receiving and displaying the preformatted response message by the wireless device.

22. The method of claim 21, wherein the step of reformulating and validating the preformatted query message comprises:
parsing the preformatted query message, and validating and storing the user and query information in a database management server;
converting a set of standardized query message field name and value pairs to a set of remote database field name and value pairs in a database output field validation server;
converting a set of standardized query message structures and relationships to a set of remote database structures and relationships in a database data-mapping server; and
forming said database query.

23. The method of claim 21, wherein the step of reformulating the database response comprises:
parsing the database response and storing database response information in the database management server;
converting a set of database response field name and value pairs to a set of standardized response message field name and value pairs in a database output field validation server;
converting a set of database response structures and relationships to a set of standardized response message structures and relationships in a database data-mapping server; and
forming said preformatted response message.

24. The method of claim 21 wherein the preformatted query message and the preformatted response message comprise:
one of an email message, an SMS message, an MMS message, an HTTP message, and a WAP message.

25. The method of claim 21, wherein said remote database comprises:
a multiple listing database.

26. The method of claim 21, further comprising:
encrypting at least one of the wireless link and the back-end link.

27. The method of claim 21, further comprising:
displaying one of the preformatted response message and the remote database response in a geographical information system.

28. The method of claim 21, further comprising:
at least one of managing account information, creating and editing query and response forms, and updating dynamic retrieval server tables and algorithms in a computing device.

29. The method of claim 21, wherein the database query and the database response comprise a predetermined database format selected from a list comprising:
SQL;
SYMBOL;
ORACLE;
SYBASE;
SAP;
ERP;
IBM AS 400;
relational;
object;
delineated;
XML; and
structured.

30. The method of claim 21, wherein said back-end link comprises a communications protocol selected from a list comprising:
an OLEDB protocol;
an ODBC protocol;
an XML protocol;
a SOAP protocol;
a RETS protocol;
a FTP protocol;
a database replication protocol; and
a database synchronization protocol.

31. The method of claim 21, further comprising at least one of:
maintaining a historical log of user or administrator actions; and
authenticating at least one of a user wireless account access and a remote database access.

32. An information management computer program product configured to enable wireless applications to interact with one or more remote world databases of predetermined format, said computer program product comprising instructions corresponding to the methods of claims 21-31.
